(19) United States
(12) Patent Application Publication
(10) Pub. No.: US 2021/0230723 A1
(43) Pub. Date: Jul. 29, 2021

(54) ALLOY COMPOSITION, FE-BASED NANO-CRYSTALLINE ALLOY AND MANUFACTURING METHOD THEREOF, AND MAGNETIC COMPONENT

(71) Applicants: Akihiro Makino, Sendai (JP); NINGBO ZHONGKE B PLUS NEW MATERIALS TECHNOLOGY CO., LTD, Ningo (CN)

(72) Inventors: Akihiro Makino, Sendai (JP); He MEN, NINGBO (CN); Hai GUO, NINGBO (CN); Lishan HUO, NINGBO (CN)

(21) Appl. No.: 17/165,380

(22) Filed: Feb. 2, 2021

Related U.S. Application Data
(63) Continuation of application No. PCT/CN2019/097735, filed on Jul. 25, 2019.

(30) Foreign Application Priority Data
Aug. 3, 2018 (JP) 2018-146884

(51) Int. Cl. C22C 38/00; C22C 38/12; C22C 38/02; C22C 38/16; H01F 1/147; C21D 6/00; C22C 33/00; H01F 1/153

(52) U.S. Cl. CPC C22C 38/002; C22C 38/12; C22C 38/02; C22C 38/004; C22C 38/16; C22C 2200/02; C21D 6/008; C22C 33/003; H01F 1/15333; C22C 2200/04; H01F 1/14766

(57) ABSTRACT

An alloy composition, a Fe-based nano-crystalline alloy and a manufacturing method thereof, and a magnetic component are disclosed. The expression of the alloy composition is FeₐV_{α}B_{b}Si_{c}PₓC_{y}Cu_{z} and 79≤a≤91 at %, 5≤b≤13 at %, 0≤c≤8 at %, 1≤x≤8 at %, 0≤y≤5 at %, 0.4≤z≤1.4 at %, 0<α<5 at % and 0.08≤z/x≤0.8(at % is atomic percent). The Fe-based nano-crystalline alloy is manufactured by subjecting the alloy composition to crystallization heat treatment. Even if the heating speed upon crystallization heat treatment is slow, or there is a deviation in the temperature reached, a Fe-based nano-crystalline alloy with high saturation magnetic induction intensity and excellent soft magnetic property can still be easily obtained from the alloy ingredients of the present invention. Moreover, the present invention provides a magnetic component manufactured using the Fe-based nano-crystalline alloy.

### CROSS-REFERENCE TO RELATED APPLICATIONS

This application is a continuation of International Patent Application No. PCT/CN2019/097735 with a filing date of Jul. 25, 2019, designating the United States, now pending, and further claims priority to Japanses Patent Application No. 2018-146884 with a filing date of Aug. 3, 2018. The content of the aforementioned applications, including any intervening amendments thereto, are incorporated herein by reference.

### TECHNICAL FIELD

The present invention relates to an alloy composition applicable to various magnetic components and having high saturation magnetic induction and excellent soft magnetic property, particularly having excellent magnetic property, a Fe-based nano-crystalline alloy and a manufacturing method thereof, and a magnetic component made from a nano-crystalline magnetic alloy.

### BACKGROUND

In the process of preparing a nano-crystalline alloy with a Fe-based soft magnetic amorphous alloy, people are accustomed to adding transition metals such as Nb and Zr for inhibiting crystal growth so as to make nanocrystallization become easy, thus obtaining the nano-crystalline alloy with excellent soft magnetic property. However, use of the transition metals such as Nb and Zr causes the problems of rising melting point, high possibility of oxidation, high cost, greatly reduced saturation magnetic induction and the like. Increase of Fe content and decrease of nonmetallic elements such as Nb can provide increased saturation magnetic induction but give rise to other problems that nanocrystallization is difficult, crystal particles become large, and soft magnetic property are worsened. Therefore, to resolve the abovementioned problems, a series of Fe-based nano-crystalline alloy are developed (see Patent Documents 1-3).

Whereas, by taking the Fe-based nano-crystalline alloy in Patent Document 1 as an example, its magnetostriction coefficient is up to 14*10-6, magnetic permeability is low, and soft magnetic property are poor. Besides, because large amount of crystal is crystallized while being rapidly cooled, the Fe-based nano-crystalline alloy in Patent document 1 has poor toughness. Thus it suffers a lot of defects as an applied material.

In view of the foregoing problems, the inventors of the present invention have developed a Fe-based nano-crystalline alloy that is comprised by the Fe, B, Si, P, C and Cu elements, and has high saturation magnetic induction and excellent soft magnetic property (see Patent Documents 4-6).

The inventors have found that, a specific alloy composition shown in Patent Documents 4-6 can be used as a starting material for obtaining the desired Fe-based nano-crystalline alloy. The alloy composition has the molecular formula: FeaBbSicPxCyCuz where 79≤a≤86 at %, 5≤b≤13 at %, 0<c≤8 at %, 1≤x≤8 at %, 0≤y≤5 at %, 0.4≤z≤1.4 at % and 0.08≤z/x≤0.8). The alloy composition has an amorphous phase as a main phase and superior toughness. α-Fe nanocrystals can be formed if the specific alloy composition is exposed to heat treatment of optimal conditions, and the magnetostriction coefficient is greatly reduced. As a result of reduced magnetostriction coefficient and formation of homogeneous nanocrystals, an alloy material with high magnetic permeability, low coercivity, and high saturation magnetic induction is obtained. Use of this specific alloy composition as a starting material is favorable of preparing the Fe-based nano-crystalline alloy having high saturation magnetic induction and high magnetic permeability.

Besides, in this Fe-based nano-crystalline alloy, the inventors of the present invention have developed a (Fe85.7Si0.5B9.5P3.5Cu0.8)99C1 alloy applicable to industrial raw materials (see Non-patent Document 1).

As for the specific alloy composition mentioned in Patent Documents 4-6, to refine crystals into nanoscale, it is necessary to heat them at the heating rate (Rh) of 300° C./min or more, and moreover, the annealing temperature after heating needs to be kept in a narrow temperature range of 30-40° C. These heat treatment conditions are easy to meet for a small amount of samples used in a lab. However, with respect to actual magnetic materials or components that weigh in a range of a few grains to tens of kilograms and vary in shape, it is an extreme difficulty in the industrial field to homogenously and rapidly heat these materials or components. Furthermore, in the proximity of the set temperature, temperature of big members can soar even the big members are melted due to plentiful heat instantaneously produced by crystallization. Because of inconsistency of local temperature rise, it is difficult to keep the annealing temperature of the actual magnetic members and parts within a narrow temperature range. Just considering the heat treatment difficulty, how to make the actual components have the magnetic property as excellent as those of experimental materials becomes a new issue that needs to be urgently resolved.
Patent Document 1: Publication No.: 2007-270271
Patent Document 2: International Publication No.: 2008/068899
Patent Document 3: International Publication No.: 2008/129803
Patent Document 4: U.S. Pat. No. 4,514,828
Patent Document 5: U.S. Pat. No. 4,584,350
Patent Document 6: U.S. Pat. No. 4,629,807

Non-patent Document 1: Kana Takenaka et al., “Industrialization of nanocrystalline Fe—Si—B—P—Cu alloy for high magnetic flux density cores”. Journal of Magnetism and Magnetic Materials, 1 Mar. 2016, Vol. 401, Pages 479-483).

### SUMMARY

It is therefore an object of the present invention to provide a Fe-based nano-crystalline alloy with high saturation magnetic induction and excellent soft magnetic property available in spite of low heating rate and biased annealing temperature and a manufacturing method thereof, and a magnetic component with excellent soft magnetic property.

After diligent study, the inventors of the present invention have found that, a specific alloy composition in which V is essential in the amorphous phase of Fe—V—B—(Si)—P—(C)—Cu serving as a main phase, can be used as the starting material to prepare the desired Fe-based nano-crystalline alloy so as to achieve the object of the present invention.

That is to say, the alloy composition of the present invention is expressed as FeaVαBbSicPxCyCuz where 79≤a≤91 at %, 5≤b≤13 at %, 0≤c≤8 at %, 1≤x≤8 at %, 0≤y≤5 at %, 0.4≤z≤1.4 at %, 0<α<5 at % and 0.08≤z/x≤0.8.

The manufacturing method of the Fe-based nano-crystalline alloy of the present invention features having the alloy composition of the present invention and heat treatment steps at the same time.

To prepare the Fe-based nano-crystalline alloy of the present invention, the alloy composition of the present invention is preferably selected. As the alloy composition of the present invention comprises the V element as an essential element, during crystallization, nano-crystalline structures can be stabilized and nanocrystals are homogenized, improving soft magnetic property. The manufacturing method of the Fe-based nano-crystalline alloy of the present invention is that by using the alloy ingredients of the present invention, even if the heating speed upon crystallization heat treatment is slow, or there is a deviation in the temperature reached, a Fe-based nano-crystalline alloy with high saturation magnetic induction intensity and excellent soft magnetic property can still be easily obtained.

The alloy composition of the present invention has an amorphous phase as a main phase, and it is preferable that its Fe content is 81 at % or more so that the Fe-based nano-crystalline alloy with high saturation magnetic induction can be obtained; if the B content is less than 10 at %, melting point is lowered and industrialized production is facilitated; if the Si content is 0.8 at % or more, the capability of forming an amorphous phase is improved, steady and continuous production of thin strips are favored, and homogenous nanocrystals can be obtained; and if the P content is between 2 at % and 5 at %, the capability of forming an amorphous phase is improved.

In the present invention, the alloy composition is optimized as 0≤y≤3 at %, 0.4≤z≤1.1 at % and 0.08≤z/x≤0.55. Therefore, constituent heterogeneity caused by volatilization of C element in melting is controlled as the C content is less than 3 at %. With the Cu content less than 1.1 at % and the ratio of z/x in the range of 0.08-0.55, brittleness of thin strips is controlled.

In the alloy composition of the present invention, 3 at % or less Fe can be replaced with at least one element selected from Ti, Zr, Hf, Nb, Ta, Mo, W, Cr, Co, Ni, Al, Mn, Ag, Zn, Sn, As, Sb, Bi, Y, N, O, Ca, Mg and rare-earth elements. Besides, the alloy composition of the present invention also comprises a nano-hetero structure having an amorphous phase and initial microcrystals existing in the amorphous phase, and the average grain size of the initial microcrystals is 0.3-10 nm.

The alloy composition of the present invention can be prepared into various alloy forms, such as continuous thin strip or powder. If it is molded in the form of a continuous thin strip, the thin strip can bend for 180° without breakage.

After subjecting heat treatment to the alloy composition of the present invention, a temperature difference (ΔT=Tx2−Tx1) between a first crystallization temperature (Tx1) and a second crystallization temperature (Tx2) is 100-200° C. α-Fe is crystallized at the first crystallization temperature (Tx1), and with temperature rising, compounds of Fe and B, P as well as Si elements are crystallized at the second crystallization temperature (Tx2).

The alloy composition of the present invention can be prepared into wound cores, laminated cores, dust cores or other magnetic cores. These magnetic cores can be used in such fields as transformers, inductors and motors.

The Fe-based nano-crystalline alloy of the present invention has the coercivity of 20 A/m or less, and the saturation magnetic induction of 1.65 T or more.

The Fe-based nano-crystalline alloy of the present invention is wide in heat treatment temperature range, high in saturation magnetic induction and excellent in soft magnetic property, and applicable to magnetic parts such as ring magnetic cores.

The Fe-based nano-crystalline alloy of the present invention has the average crystallized grain size of 5-25 nm, and for the purpose of preventing magnetism worsening, saturation magnetostriction coefficient is 10*10-6 or less, even 5*10-6 or less.

The magnetic component is made from the Fe-based nano-crystalline alloy of the present invention. The magnetic component of the present invention can comprise a transformer, an inductor, a motor or the like prepared from the Fe-based nano-crystalline alloy of the present invention.

According to the present invention, regardless of low heating rate and biased annealing temperature, an alloy composition having high saturation magnetic induction, a Fe-based nano-crystalline alloy made from the alloy composition and having high saturation magnetic induction and a manufacturing method thereof, and a Fe-based nano-crystalline magnetic component are easily reachable.

### BRIEF DESCRIPTION OF THE DRAWINGS

FIG. 1 is a DSC graph showing Embodiments 1-8 and Comparative Examples 1-3 without V element of the present invention.

FIG. 2 (a) is a view showing the relation between heat treatment heating rate and coercivity of the Fe-based nano-crystalline alloy of Embodiments 1-3 and Comparative Example 1 of the present invention at the set annealing temperature of 420° C.

FIG. 2 (b) is a view showing the relation between heat treatment heating rate and coercivity of the Fe-based nano-crystalline alloy of Embodiments 2-3 and Comparative Example 1 of the present invention at the set annealing temperature of 430° C.

FIG. 3 is a view showing the relation between heat treatment heating rate and α-Fe grain sizes of the Fe-based nano-crystalline alloy of Embodiments 1-3 and Comparative Example 1 of the present invention at the set annealing temperature of 430° C.

FIG. 4 (a) is a view showing the relation between heat treatment heating rate and coercivity of the Fe-based nano-crystalline alloy of Embodiments 4-5 and Comparative Examples 1-2 of the present invention at the set annealing temperature of 420° C.

FIG. 4 (b) is a view showing the relation between heat treatment heating rate and coercivity of the Fe-based nano-crystalline alloy of Embodiments 4-5 and Comparative Examples 1-2 of the present invention at the set annealing temperature of 430° C.

FIG. 5 is a view showing the relation between heat treatment heating rate and coercivity of the Fe-based nano-crystalline alloy of Embodiments 4 and 6 and Comparative Examples 1-2 of the present invention at the set annealing temperature of 420° C.

FIG. 6 is a view showing the relation between heat treatment heating rate and coercivity of the Fe-based nano-crystalline alloy of Embodiments 7-8 and Comparative Examples 1 and 3 of the present invention at the set annealing temperature of 410° C.

FIG. 7 (a) is a view showing the relation between heat treatment annealing temperature and coercivity of the Fe-based nano-crystalline alloy of Embodiments 1-3 and Comparative Example 1 of the present invention at the heating rate of 300° C./min.

FIG. 7 (b) is a view showing the relation between heat treatment annealing temperature and coercivity of the Fe-based nano-crystalline alloy of Embodiments 1-3 and Comparative Example 1 of the present invention at the heating rate of 150° C./min.

FIG. 8 is a view showing the relation between the set heat treatment annealing temperature and coercivity of the Fe-based nano-crystalline alloy of Embodiments 4-5 and Comparative Examples 1-2 of the present invention at the heating rate of 150° C./min.

FIG. 9 is a view showing the relation between magnetic core weight and coercivity of the Fe-based nano-crystalline alloy of Embodiment 1 and Comparative Example 1 of the present invention at the set annealing temperature of 420° C., and respectively at the heating rate of 100° C./min, 150° C./min and 300° C./min.

### EMBODIMENTS

The present invention will be further explained by referring to the examples and drawings below. In the present invention, at % means atomic percentage.

The alloy composition of the present invention is expressed as FeaVαBbSicPxCyCuz where 79≤a≤91 at %, 5≤b≤13 at %, 0≤c≤8 at %, 1≤x≤8 at %, 0≤y≤5 at %, 0.4≤z≤1.4 at %, 0<α<5 at % and 0.08≤z/x≤0.8.

The preparation of the Fe-based nano-crystalline alloy of the present invention comprises preparation of the alloy composition of the present invention and a crystallization heat treatment step.

The alloy composition of the present invention is exposed to heat treatment under the protection of Ar-gas atmosphere, and is subjected to crystallization twice or more. In the above process, the α-Fe phase is crystallized at the first crystallization temperature (Tx1), and at a higher temperature, compounds of Fe and B, P as well as Si elements are crystallized at the second crystallization temperature (Tx2). The term “crystallization start temperature” refers to a first crystallization start temperature, and the first crystallization start temperature and a second crystallization start temperature can be evaluated through a differential scanning calorimetry (DSC) apparatus.

The alloy composition of the present invention is suitable for preparation of the Fe-based nano-crystalline alloy of the present invention.

As the alloy composition of the present invention comprises the V element as an essential element, therefore during crystallization, nano-crystalline structures can be stabilized and nanocrystals are homogenized, improving soft magnetic property. However, if the V content is more than 5 at %, the capability of forming an amorphous phase and saturation magnetic induction are reduced. Furthermore, the alloy composition of the present invention has an amorphous phase as the main phase.

In the alloy composition of the present invention, the Fe element as an essential element contributes to improving saturation magnetic induction and reducing material cost. If the Fe content is less than 79 at %, desired saturation magnetic induction is inaccessible. If the Fe content is over 91 at %, it is difficult to form an amorphous phase with a rapid cooling process, and coarse α-Fe crystals are formed. In this case, homogenous nano-crystalline structures are not available, leading to reduction of soft magnetic property. In particular, if saturation magnetic induction of 1.7 T or more is required, it is preferable that the Fe content is 81 at % or more.

In the alloy composition of the present invention, the B element as an essential element contributes to improving the capability of forming an amorphous phase. If the B content is less than 5 at %, it is difficult to form an amorphous phase with a rapid cooling process. If the B content is more than 13 at %, temperature difference (ΔT=Tx2−Tx1) of Tx2 and Tx1 is reduced, which is adverse to obtaining homogeneous nano-crystalline structures, leading to reduction of soft magnetic property. In particular, if the alloy composition is required to have its low melting point for industrialized production, it is preferable that the B content is 10 at % or less.

The alloy composition of the present invention comprises the Si element that can inhibit crystallization of compounds of Fe and B elements from the crystallized nano-crystalline structures so as to stabilize the nano-crystalline structures. If the Si content is more than 8 at %, the saturation magnetic induction and the capability of forming an amorphous phase are lowered, leading to worsening of soft magnetic property. In particular, if the Si content is 0.8 at % or more, the capability of forming an amorphous phase is improved, steady and continuous production of thin strips is achievable. Besides, homogenous nano-crystalline structures can be obtained as a result of rising ΔT.

In the alloy composition of the present invention, the P element as an essential element is conductive to improving the capability of forming an amorphous phase. If the P content is less than 1 at %, it is difficult to form an amorphous phase with a rapid cooling process. If the P content is more than 8 at %, saturation magnetic induction is lowered, leading to worsening of soft magnetic property. Especially, if the P content is in a range of from 2 at % to 5 at %, the capability of forming an amorphous phase is improved.

In the alloy composition of the present invention, the capability of forming an amorphous phase is improved due to containing the C element. Because the C element is inexpensive, addition of the C element decreases the content of the other metalloids so that the total material cost is reduced. If the C content is over 5 at %, brittleness is caused, leading to reduction of soft magnetic property. Especially, if the C content is 3 at % or less, constituent segregation caused by volatilization of the C element can be inhibited.

In the alloy composition of the present invention, the Cu element as an essential element contributes to nanocrystallization. The Cu element is expensive and, if the Fe content is more than 81 at %, causes the alloy composition to be easy to be brittle or be oxidized. If the Cu content is less than 0.4 at %, it is adverse to nanocrystallization. If the Cu content is more than 1.4 at %, an amorphous phase is heterogeneous, so that homogeneous nano-crystalline structures are difficult to form, leading to reduction of soft magnetic property. In particular, considering brittleness of the nano-crystalline alloy, it is preferable that the Cu content is controlled to be 1.1 at % or less.

In the alloy composition of the present invention, a combination of the B element, the Si element, the P element and the C element also can improve the capability of forming an amorphous phase and increase the stability of the nano-crystalline structures, in comparison with a case where only one of the B element, the Si element, the P element and the C element is used. Besides, a combination of the Si element, the B element, the P element, the Cu element and the V element, or a combination of the Si element, the B element, the P element, the C element, the Cu element and the V element further favors stabilization of nano-crystalline structures.

There is a large attraction force between P atom and Cu atom. Therefore, if the alloy composition includes a specific ratio of the P element and the Cu element, clusters are formed therein with a rapid cooling process to have a size of 10 nm or less so that the nano-size clusters cause bccFe crystals to have microstructures upon the formation of the Fe-based nano-crystalline alloy. Meantime, because of containing the V element, the nano-crystalline structures are stable. Hence, the Fe-based nano-crystalline alloy has the average grain size of 5-25 nm. If the ratio (z/x) of the Cu content (z) to the P content (x) is less than 0.08 or more than 0.8, homogeneous nano-crystalline structures cannot be obtained, leading to reduction of soft magnetic property. It is preferable that the ratio (z/x) is 0.08-0.55, in consideration of brittleness.

In view of the above, in preparing a Fe-based nano-crystalline alloy with the alloy composition of the present invention, regardless of low heat treatment heating rate and biased annealing temperature, the Fe-based nano-crystalline alloy with high saturation magnetic induction and excellent soft magnetic property can be obtained.

In the alloy composition of the present invention, Fe can be replaced with at least one element selected from the group consisting of Ti, Zr, Hf, Nb, Ta, Mo, W, Cr, Co, Ni, Al, Mn, Ag, Zn, Sn, As, Sb, Bi, Y, N, O, Ca, Mg and rare-earth elements at 3 at % or less.

The alloy prepared from the alloy composition of the present invention can have various shapes. For example, the alloy can have a continuous thin strip shape or can be formed in a powder form. The continuous thin strip shape of the alloy can be formed by using a single roll formation apparatus or a double roll formation apparatus, which are used to form a Fe-based amorphous thin strip. Besides, if the Si content is 0.8 at % or more or the P content is 2-5 at %, the capability of forming an amorphous phase is improved and continuous and steady thin strip preparation is achieved. Moreover, the prepared continuous thin strip can bend for 180° without breakage. The powder form of the alloy can be formed in a water atomization method or a gas atomization method, or can be formed by crushing a thin strip.

The alloy prepared from the alloy composition of the present invention can be prepared into wound cores, laminated cores, dust cores or other magnetic cores. These magnetic cores can be used in such fields as transformers, inductors and motors.

For the alloy prepared from the alloy composition of the present invention, the temperature difference (ΔT=Tx2−Tx1) between Tx2 and Tx1 is 100-200° C., so the heat treatment temperature range is wide from the perspective of industrialized production. Considering heating in the heat treatment process, it is better if Tx2 is higher. The V element in the alloy composition of the present invention is beneficial to increase of ΔT, particularly to increase of Tx2. Due to dramatic heating in the crystallization process, temperature of a heat treated object is higher than the set temperature, therefore, addition of the V element can increase the crystallization temperature Tx2 of compounds capable of worsening soft magnetic property. Hence, the Fe-based nano-crystalline alloy with excellent soft magnetic property can be prepared from the alloy composition in a wide heat treatment temperature range.

In addition, in the process of preparing the Fe-based nano-crystalline alloy from the alloy composition of the present invention, temperature is increased at the heating rate of 100˜300° C./min. Even if heat treatment is carried out at the temperature higher than the crystallization start temperature (i.e., the first crystallization start temperature), the Fe-based nano-crystalline alloy of the present invention is also obtainable. Considering that crystallization of compounds of Fe causes worsening of soft magnetic property, the heat treatment temperature needs to be in the range of Tx1-Tx2.

The Fe-based nano-crystalline alloy with high saturation magnetic induction and excellent soft magnetic property can be prepared from the alloy composition of the present invention in a wide temperature range. Therefore, the Fe-based nano-crystalline alloy can be prepared into magnetic parts, such as magnetic rings. The Fe-based nano-crystalline alloy of the present invention has the coercivity of 20 A/m or less, and saturation magnetic induction of 1.65 T or more. Besides, the Fe-based nano-crystalline alloy prepared from the alloy composition of the present invention has the saturation magnetostriction coefficient of 10*10-6 or less, even 5*10-6 or less, to prevent worsening of soft magnetic property.

The magnetic component is made from the Fe-based nano-crystalline alloy of the present invention. The magnetic component of the present invention can be a magnetic core of a transformer, an inductor, a motor or the like prepared from the Fe-based nano-crystalline alloy of the present invention.

### Embodiments of the Alloy

Preparation of the alloy comes first. Referring to Embodiments 1-8 as listed in Tables 1-4, raw materials were respectively weighted at a certain ratio, and then melted by an induction furnace. Melted master alloy were processed into thin strips that are 20 μm thick and 10 mm wide by virtue of a single-roll quenching method in the atmosphere. Moreover, thin strips of compositions in Comparative Examples 1-3 as listed in Tables 1-4 were produced by the same method. The alloy of Comparative Example 1 is the (Fe85.7Si0.5B9.5P3.5Cu0.8)99C1 alloy mentioned in the Non-patent Document 1.

TABLE 1

| | | Phase | Tx1 | Tx2 | ΔT | Hc | Bs |
|---|---|---|---|---|---|---|---|
| | Composition (atomic %, at %) | (XRD) | (° C.) | (° C.) | (° C.) | (A/m) | (T) |
| Comparative | (Fe_{85.7}Si_{0.5}B_{9.5}P_{3.5}Cu_{0.8})C₁ | Amo | 395 | 534 | 139 | 13.9 | 1.57 |
| Example 1 | | | | | | | |
| Embodiment 1 | (Fe_{85.6}Si_{0.5}B_{9.5}P_{3.5}Cu_{0.8}V_{0.1})C₁ | Almost | 397 | 531 | 134 | 18.9 | 1.57 |
| | | amo | | | | | |
| Embodiment 2 | (Fe_{85.2}Si_{0.5}B_{9.5}P_{3.5}Cu_{0.8}V_{0.5})C₁ | Almost | 397 | 537 | 141 | 15.7 | 1.56 |
| | | amo | | | | | |
| Embodiment 3 | (Fe_{84.7}Si_{0.5}B_{9.5}P_{3.5}Cu_{0.8}V₁)C₁ | Almost | 399 | 545 | 145 | 18.2 | 1.56 |
| | | amo | | | | | |

TABLE 2

| | | | Tx1 | Tx2 | ΔT | Hc | Bs |
|---|---|---|---|---|---|---|---|
| | Composition (atomic %, at %) | Phase (XRD) | (° C.) | (° C.) | (° C.) | (A/m) | (T) |
| Comparative | Fe_{84.7}Si_{0.5}B_{9.94}P_{4.04}Cu_{0.8} | Amo | 397 | 530 | 133 | 13.9 | 1.56 |
| Example 2 | | | | | | | |
| Embodiment 4 | (Fe_{84.8}Si_{0.5}B_{9.9}P₄Cu_{0.8})V_{0.1} | Almost amo | 398 | 531 | 132 | 15.7 | 1.56 |
| Embodiment 5 | (Fe_{84.8}Si_{0.5}B_{9.9}P₄Cu_{0.8})V₁ | Amo + Cry | 404 | 545 | 141 | 17.4 | 1.57 |

TABLE 3

| | | Phase | Tx1 | Tx2 | ΔT | Hc | Bs |
|---|---|---|---|---|---|---|---|
| | Composition (atomic %, at %) | (XRD) | (° C.) | (° C.) | (° C.) | (A/m) | (T) |
| Comparative | Fe_{84.7}Si_{0.5}B_{9.94}P_{4.04}Cu_{0.8} | Amo | 397 | 530 | 133 | 13.9 | 1.56 |
| Example 2 | | | | | | | |
| Embodiment 6 | Fe_{84.7}Si_{0.5}B_{9.94}P_{4.04}Cu_{0.8}V_{0.01} | Almost amo | 401 | 533 | 132 | 13.3 | 1.56 |
| Embodiment 4 | (Fe_{84.8}Si_{0.5}B_{9.9}P₄Cu_{0.8})V_{0.1} | Almost amo | 398 | 531 | 132 | 15.7 | 1.56 |

TABLE 4

| | | | Tx1 | Tx2 | ΔT | Hc | Bs |
|---|---|---|---|---|---|---|---|
| | Composition (atomic %, at %) | Phase (XRD) | (° C.) | (° C.) | (° C.) | (A/m) | (T) |
| Comparative | Fe_{85.2}B_{10.4}F_{3.6}Cu_{0.8} | Amo | 400 | 531 | 131 | 15.8 | 1.56 |
| Example 3 | | | | | | | |
| Embodiment 7 | Fe_{84.7}B_{10.4}P_{3.6}Cu_{0.8}V_{0.5} | Amo | 402 | 540 | 138 | 13.5 | 1.56 |
| Embodiment 8 | Fe_{84.2}B_{10.4}F_{3.6}Cu_{0.8}V₁ | Almost amo | 405 | 545 | 140 | 15.2 | 1.55 |

In Embodiments 1-3 of Table 1, 0.1-1 at % of Fe element in composition of Comparative Example 1 is replaced with the V element. In Embodiment 4-5 of Table 2, 0.1-1 at % of the whole composition in Comparative Example 2 is replaced with the V element. In Embodiments 4 and 6 of Table 3, 0.01-0.1 at % of B element and P element in composition of Comparative Example 2 is replaced with the V element. Table 4 shows the composition without Si element, and in Embodiments 7-8, 0.1-1 at % of Fe element in composition of Comparative Example 3 is replaced with the V element.

The produced thin strips of the alloy of Embodiments 1-8 and Comparative Examples 1-3 were subjected to phase identification with an X-ray diffraction method (XRD). The first crystallization start temperature (Tx1) and the second crystallization start temperature (Tx2) of each alloy composition were measured by using a differential scanning calorimetry (DSC) at the heating rate of 40° C./min.

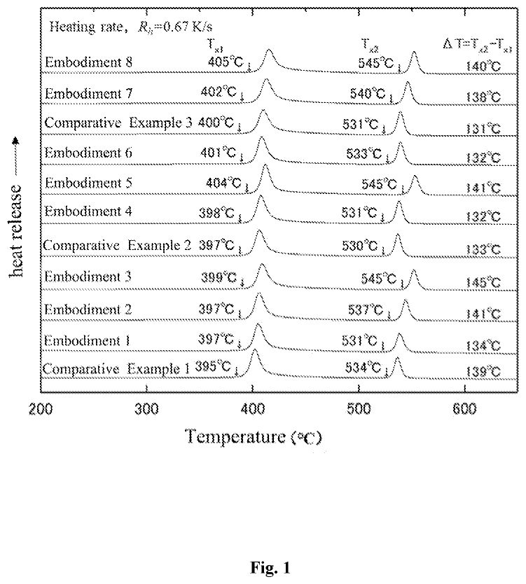

The measured phase of each alloy composition is shown in Tables 1-4. Besides, the DSC graph of each alloy composition is shown in FIG. 1. The detected Tx1, Tx2 and ΔT (=Tx2−Tx1) are also given in FIG. 1 and Tables 1-4. As Seen from Tables 1-4, the alloy compositions of Embodiments 1-4 and 6-8 are amorphous (Amo) or almost amorphous (Almost Amo). The alloy composition of Embodiment 5 comprises an amorphous phase as a main phase and a portion of crystal phase (Cry). Moreover, the alloy compositions of Comparative Examples 1-3 are amorphous (Amo).

It is proved that the V element contained in the alloy compositions of Embodiments 1-8 is beneficial to increasing crystallization temperature difference ΔT and promoting Tx2. Increase of Tx2 facilitates improvement of heat stability of nano-crystalline structures, so even if crystallization heating is accompanied in the heat treatment process, compounds of Fe element are difficult to crystallize and soft magnetic property of alloy are free of reduction. After ΔT rises, the alloy can show good soft magnetic property in a wide heat treatment temperature range. Comparing Embodiments 2-8 in FIG. 1 and Tables 1-4 with all Comparative Examples in the Tables 1-4, Tx2 is indeed increased; and ΔT is also increased by comparing Embodiments 2, 3, 5, 7 and 8 with all Comparative Examples in Tables 1-4.

With regard to the thin strips prepared from the alloy of Embodiments 1-8 and Comparative Examples 1-3, their saturation magnetic induction (Bs) was measured by using a vibrating-sample magnetometer (VSM) under a magnetic field of 800 kA/m, with the measurement results shown in Tables 1-4. It is found from Tables 1-4 that, the saturation magnetic induction of the alloy of Embodiments 1-8 is between 1.55 T and 1.57 T, that is to say, even if the V element is added, the alloy of Embodiments 1-8 and the alloy of Comparative Examples 1-3 almost have the same saturation magnetic induction.

### Embodiments of the Fe-Based Nano-Crystalline Alloy

Next, the Fe-based nano-crystalline alloy of the present invention was prepared. 50 mm long thin strips prepared from the alloy of Embodiments 1-8 and Comparative Examples 1-3 were cut out, ten cut alloy sections as a group were cladded by aluminum foils, then the cladded samples were placed in an infrared heat treatment furnace and then subjected to heat treatment under the protection of Ar-gas atmosphere, and finally nano-crystalline alloy of Embodiments 1-8 and Comparative Examples 1-3 were obtained. The heat treatment conditions were as follows: different heating rates (Rh) and different annealing temperatures (Ta) in heat treatment were set in accordance with different alloy compositions, and temperature reservation was carried out for 10 min after each set annealing temperature was up.

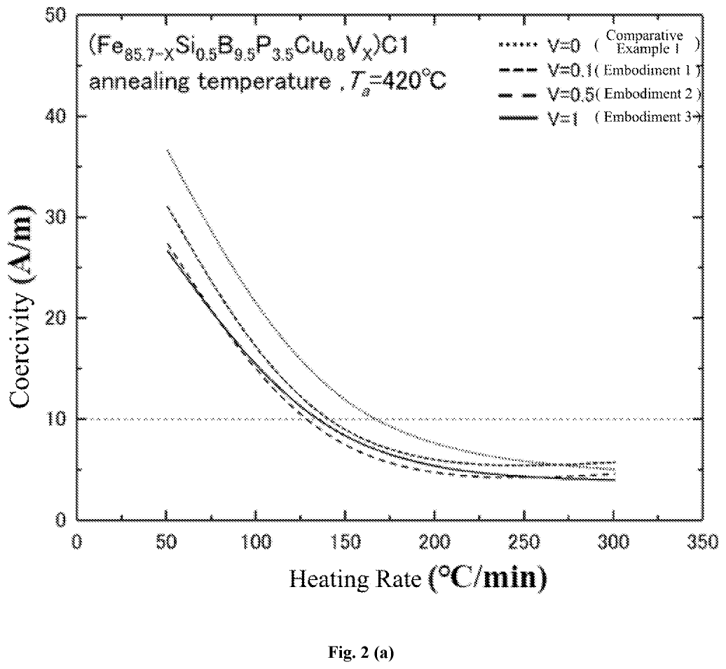

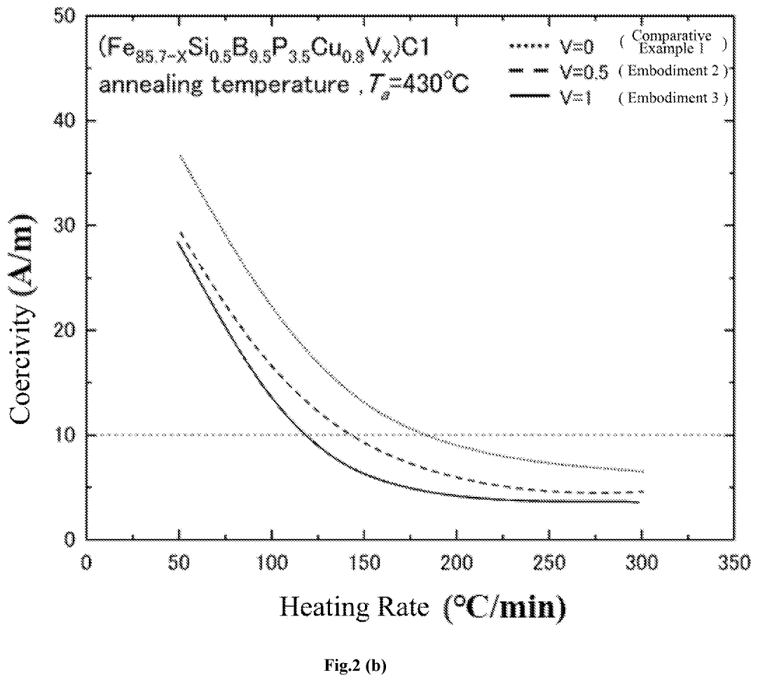

The coercivity (Hc) of the thin strips of the Fe-based nano-crystalline alloy was measured by using a direct current B-H tracer under a magnetic field of 2 kA/m. α-Fe grain sizes of the Fe-based nano-crystalline alloy were calculated with a Scherrer formula based on the full width at half maximum of an XRD spectrum. The measurement results are given in Tables 1-4 and FIGS. 2-9. Besides, saturation magnetic induction of the thin strips of the nano-crystalline alloy was also measured. The saturation magnetic induction of all nano-crystalline alloy of Embodiments 1-8 is 1.7 T or more, and thus is high.

### Embodiments of Improving the Dependence of Coercivity on Heat Treatment Heating Rate

The dependence of coercivity of the Fe-based nano-crystalline alloy of Embodiments 1-3 and Comparative Example 1 on heat treatment heating rate seen from Table 1 is respectively shown in FIG. 2 (a) and FIG. 2 (b). The set annealing temperatures in FIG. 2 (a) and FIG. 2 (b) are respectively 420° C. and 430° C., which are the optimal heat treatment temperatures.

In FIG. 2 (a) and FIG. 2 (b), at the heating rate of 50-300° C./min, by comparing the alloy of Embodiments 1-3 containing V element with the alloy of Comparative Example 1 without V element, the alloy of Embodiments 1-3 have lower coercivity. As shown in FIG. 2 (a), when the set annealing temperature is 420° C. and the excellent soft magnetic property, i.e., coercivity of 10 A/m or less is reached, the lower limit of the heating rate for the alloy of Comparative Example 1 without V element is 170° C./min, while it is 130˜140° C./min for the alloy of Embodiments 1-3 containing 0.1 at % or more of the V element. As shown in FIG. 2 (b), when the set annealing temperature is 430° C. and the excellent soft magnetic property, i.e., coercivity of 10 A/m or less is reached, the lower limit of the heating rate for the alloy of Comparative Example 1 without V element is 180° C./min, while it is merely 120˜140° C./min for the alloy of Embodiments 1-3 containing 0.1 at % or more of V element.

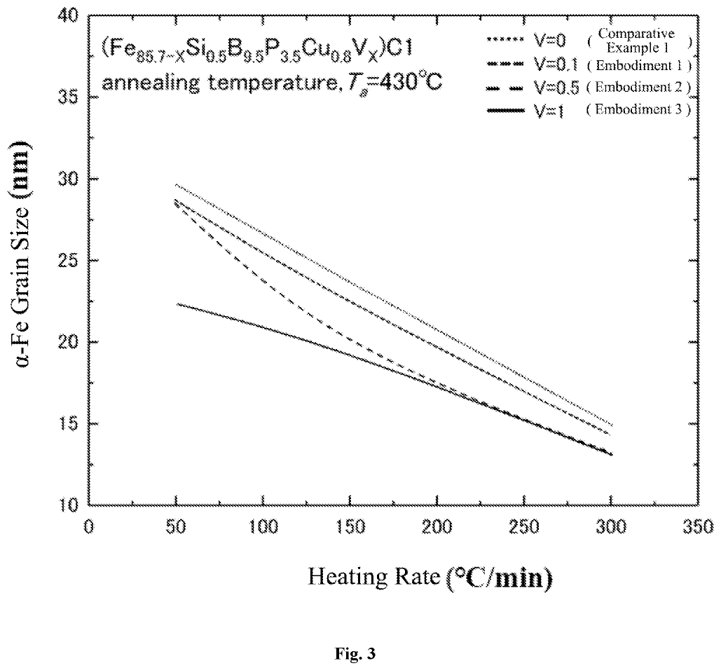

FIG. 3 is a graph showing a dependency relation between α-Fe grain sizes of the Fe-based nano-crystalline alloy of Embodiments 1-3 and Comparative Example 1 and heat treatment heating rate at the set annealing temperature of 430° C. As Seen from FIG. 3, in the whole heating rate range, due to addition of the V element, α-Fe crystals become small. Therefore, as shown in FIG. 2, addition of the V element plays a role in effectively lowering coercivity and refining crystals.

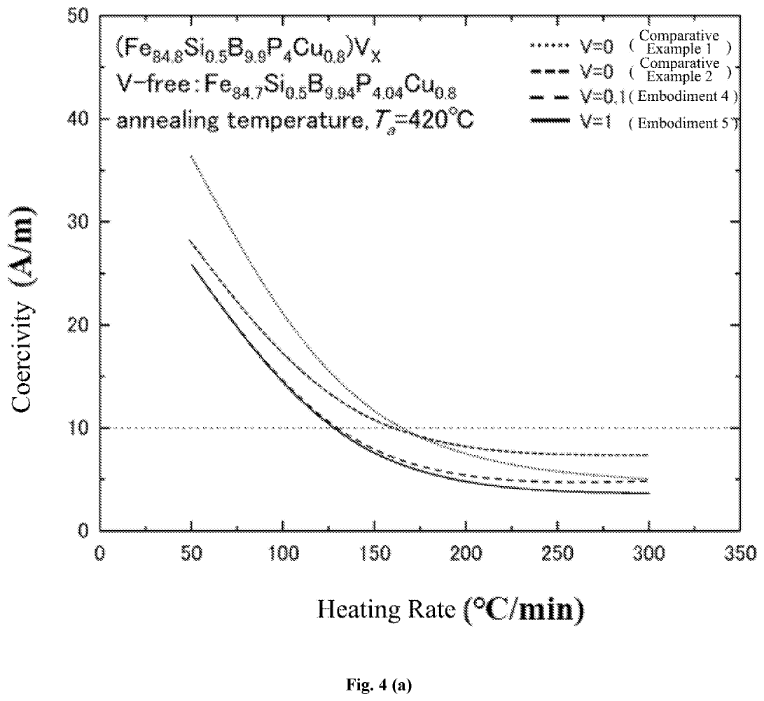

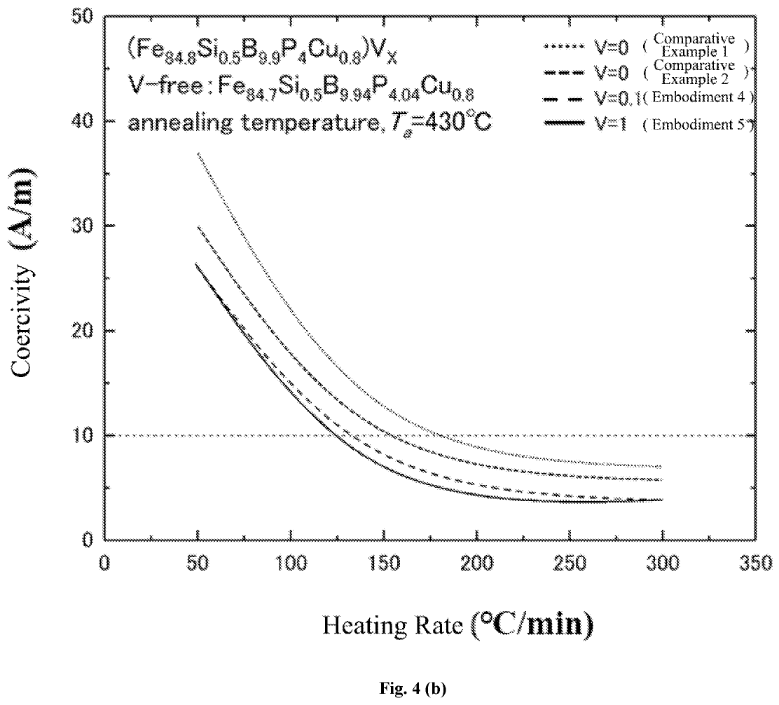

FIG. 4 (a) and FIG. 4 (b) show a dependency relation between coercivity of the Fe-based nano-crystalline alloy of Embodiments 4-5 and Comparative Examples 2 and 1 in Table 2 and the heat treatment heating rate. The set annealing temperatures in FIG. 4 (a) and FIG. 4 (b) are respectively 420° C. and 430° C., which are the optimal heat treatment temperatures.

In FIG. 4(a) and FIG. 4(b), at the heating rate of 50˜300° C./min, by comparing the alloy of Embodiments 4-5 containing V element with those of Comparative Examples 1-2 without V element, the alloy of Embodiments 4-5 have lower coercivity. As shown in FIG. 4 (a), when the set annealing temperature is 420° C. and the excellent soft magnetic property, i.e., coercivity of 10 A/m or less is reached, the lower limit of the heating rate for the alloy of Comparative Examples 1-2 without V element is 160-170° C./min, while it is reduced to 135° C./min for the alloy of Embodiments 4-5 containing 0.1 at % or more of V element. As shown in FIG. 4 (b), when the set annealing temperature is 430° C. and the excellent soft magnetic property, i.e., coercivity of 10 A/m or less is reached, the lower limit of the heating rate for the alloy of Comparative Examples 1-2 without V element is 150-180° C./min, while it is merely about 125-130° C./min for the alloy of Embodiments 4-5 containing 0.1 at % or more of V element.

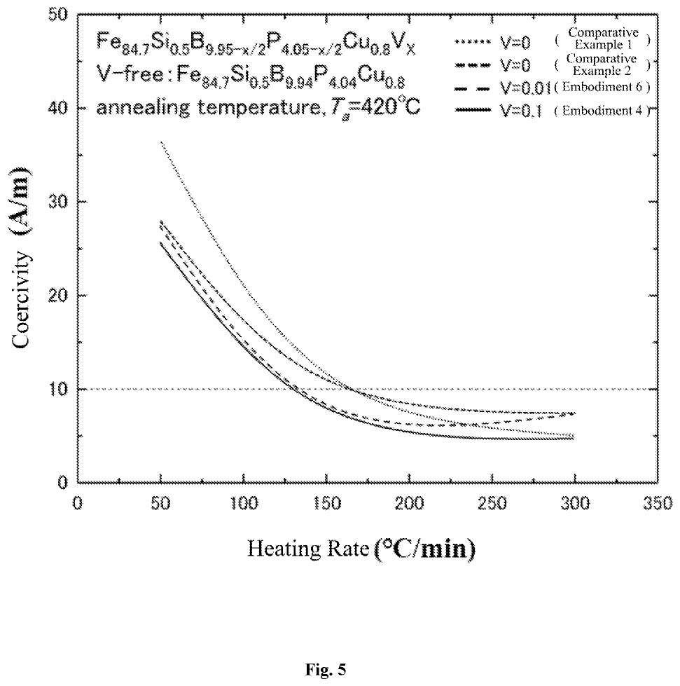

FIG. 5 shows a dependency relation between coercivity of the Fe-based nano-crystalline alloy of Embodiments 4 and 6 and Comparative Example 2 in Table 3 and heat treatment heating rate. The annealing temperature (Ta) is 420° C., which is the optimal heat treatment temperature.

In FIG. 5, at the heating rate of 50˜300° C./min, by comparing the alloy of Embodiments 4 and 6 containing V element with the alloy of Comparative Example 2 without V element, the alloy of Embodiments 4 and 6 have lower coercivity. When the excellent soft magnetic property, i.e., coercivity of 10 A/m or less is reached, the lower limit of the heating rate for the alloy of Comparative Examples 1-2 without V element is about 170° C./min, while it is about 130° C./min for the alloy of Embodiments 4 and 6 containing 0.01 at % or more of the V element.

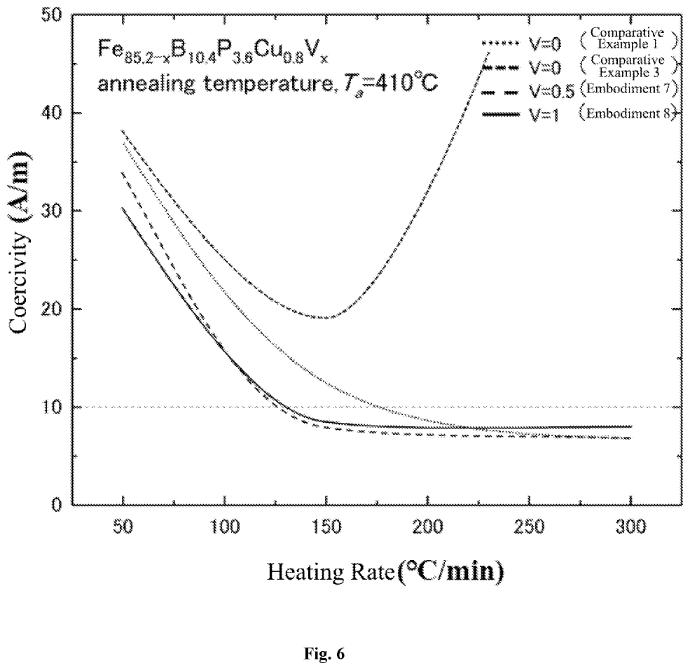

FIG. 6 shows a dependency relation between coercivity of the Fe-based nano-crystalline alloy of Embodiments 7-8 and Comparative Examples 3 and 1 and heat treatment heating rate. The annealing temperature (Ta) is 410° C., which is the optimal heat treatment temperature.

In FIG. 6, at the heating rate of 500-300° C./min, by comparing the alloy of Embodiments 7-8 containing the V element with the alloy of Comparative Example 3 without V element, the alloy of Embodiments 7-8 have lower coercivity. The alloy in Comparative Example 3 without V element cannot get such excellent soft magnetic property as coercivity of 10 A/m or less at any heating rate, but the alloy of Embodiments 7-8 containing 0.5 at % or more of the V element can have the coercivity of 10 A/m or less at the heating rate of about 135° C./min or more.

It is found from the results of FIGS. 2-6 that, due to addition of the V element, even if heat treatment heating rate is lowered, the alloy of the present invention can still obtain excellent soft magnetic property.

### Embodiments of Improving Dependence of Coercivity on Heat Treatment Annealing Temperature

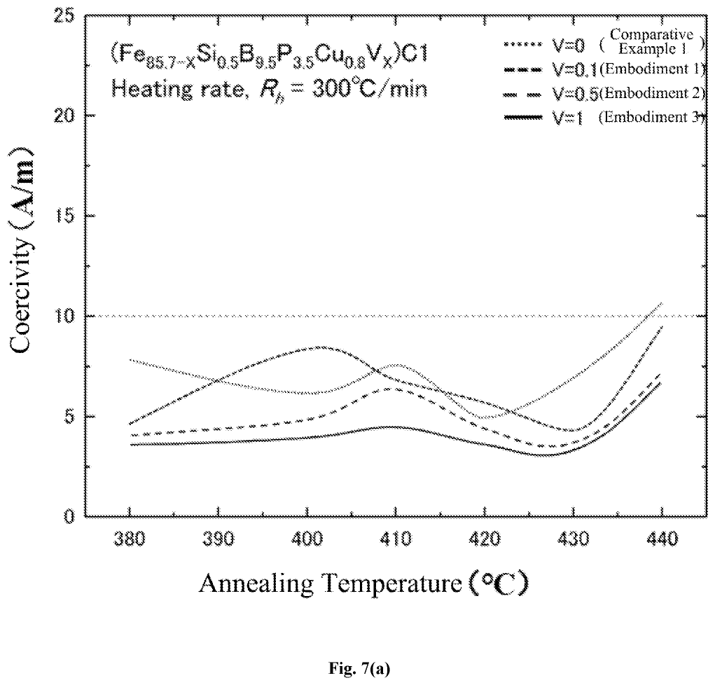

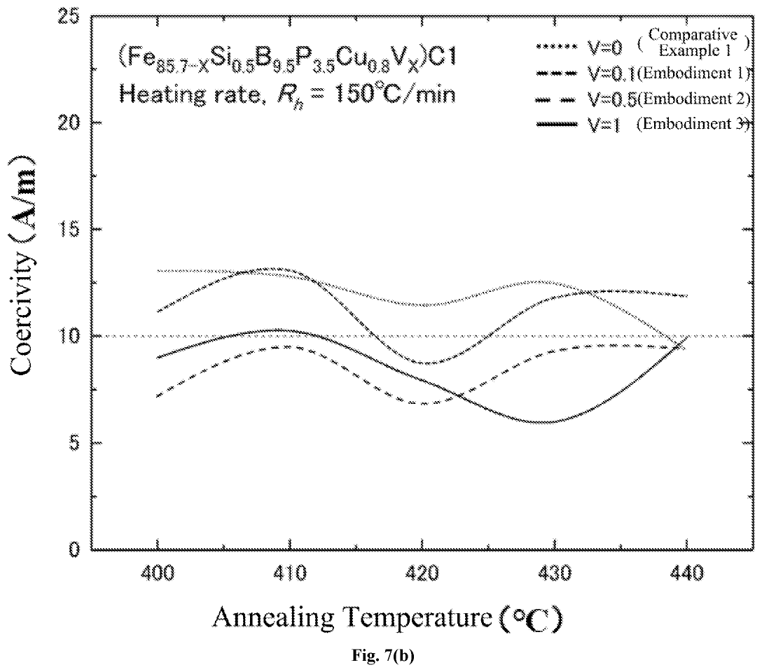

FIG. 7 (a) and FIG. 7 (b) show a dependency relation between coercivity of the Fe-based nano-crystalline alloy of Embodiments 1-3 and Comparative Example 1 in Table 1 and heat treatment annealing temperature. As shown in FIG. 7 (a), at the heating rate Rh of 300° C./min, by comparing the alloy of Embodiments 1-3 containing the V element with the alloy of Comparative Example 1 without V element, the alloy of Embodiments 1-3 have lower coercivity in the temperature range of 380-440° C. For the alloy in Comparative Example 1 without V element, when temperature exceeds 440° C., coercivity is over 10 A/m, and soft magnetic property are rapidly worsened. By contrast, the alloy of Embodiments 1-3 containing 0.1 at % or more of the V element also have excellent soft magnetic property, i.e., coercivity of 10 A/m or less even at the temperature of 440° C. Therefore, addition of V element is helpful to effectively preventing worsening of soft magnetic property and ensuring high saturation magnetic induction in high temperature areas.

As shown in FIG. 7 (b), at the heating rate Rh of 150° C./min, the alloy of Comparative Example 1 without V element has the coercivity of less than 10 A/m only at the temperature of 440° C. By contrast, for the alloy of Embodiments 2-3 containing 0.5 at % or more of the V element, the temperature range is expanded to 415-440° C. where coercivity of less than 10 A/m is reachable. That is to say, due to addition of the V element, even at the low heating rate of 150° C./min, coercivity of 10 A/m or less can be obtained in a wide temperature range. This point has an important significance on lowering requirements of the heat treatment technology in actually industrialized production.

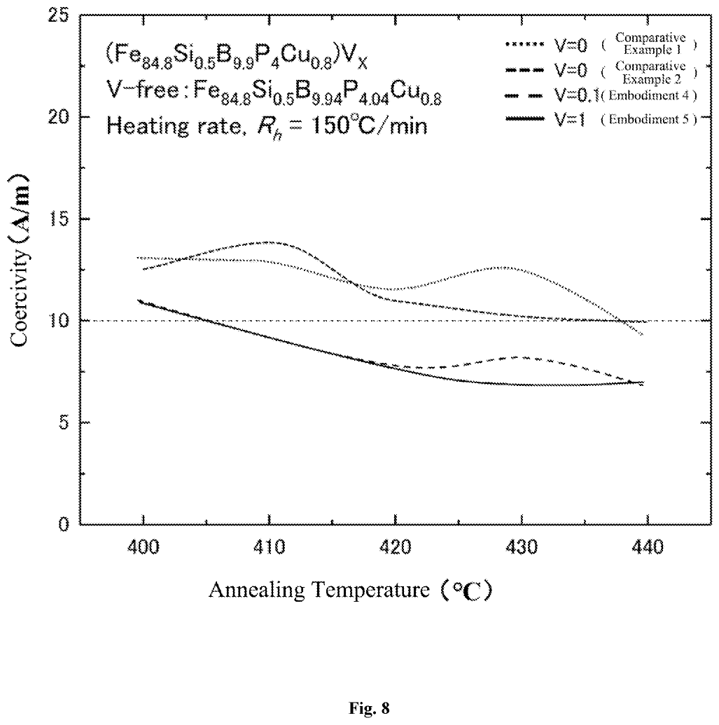

FIG. 8 shows a dependency relation between coercivity of the Fe-based nano-crystalline alloy of Embodiments 4-5 and Comparative Examples 2 and 1 and heat treatment annealing temperature. As shown in FIG. 8, at the heating rate Rh of 150° C./min, by comparing the alloy of Embodiments 4-5 containing 0.1 at % or more of the V element with the alloy of Comparative Examples 1-2 without V element, the alloy of Comparative Examples 1-2 without V element can have the coercivity of less than 10 A/m only at the temperature of 440° C. Conversely, for the alloy of Embodiments 4-5, the temperature range is expanded to 405-440° C. where coercivity of less than 10 A/m is reachable. That is to say, just like FIG. 7 (b), due to addition of the V element, even at the low heating rate of 150° C./min, coercivity of 10 A/m or less can be obtained in a wide temperature range.

### Embodiments of Improving Coercivity of Wound Cores after Heat Treatment by Heat Treatment Conditions

In a heating process, it is easy to uniformly heat short thin strip-shaped materials. However, for a wound core, its exterior is prone to heat up along with a furnace, while the heating rate of its interior is slower than that of the surface. This is more obvious in rapid heat treatment. Even when the target temperature is up and heat is instantaneously released by crystallization, the iron core is rapidly heated. The heat is in direct proportion to the volume of the material, namely, the heavier the iron core is, the more obvious this effect plays. Moreover, the higher the heating rate is, the easier the crystallization heating is caused, and the higher the temperature rises.

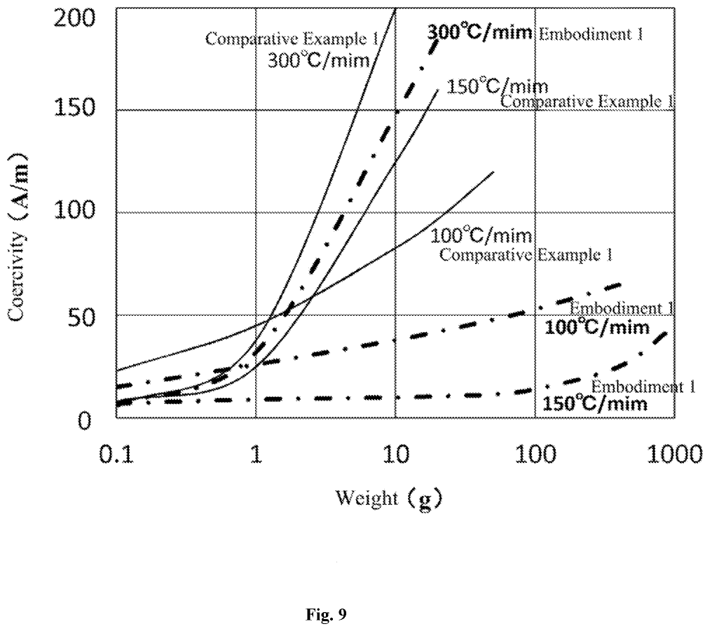

Two continuous alloy thin strips of Embodiment 1 and Comparative Example 1 were prepared, two 0.1 g of short thin strips were respectively cut out, wound cores of 1 g, 10 g and 100 g were respectively prepared and then subjected to heat treatment at the temperature rate of 100-300° C./min and at the annealing temperature of 420° C. The temperature difference between the actual temperature higher than a set annealing temperature and the set annealing temperature due to crystallization heating was tested, and grain sizes and coercivity of all materials after heat treatment were measured. The measurement results are shown in Table 5 and FIG. 9.

TABLE 5

| | Heating | | Maximum | Grain | |
|---|---|---|---|---|---|
| | Rate (° C/min.) | Weight (g) | Temperature (° C.) | Size (nm) | Hc(A/m) |
| Comparative | 100 | 0.1 | 420 | 24 | 23 |
| Example 1 | | 1 | 490 | 27 | 45 |
| | | 10 | 520 | 30 | 83 |
| Comparative | 150 | 0.1 | 422 | 23 | 12 |
| Example 1 | | 1 | 495 | 25 | 21 |
| | | 10 | 536 | 33 | 150 |
| Comparative | 300 | 0.1 | 425 | 18 | 6 |
| Example 1 | | 1 | 482 | 26 | 35 |
| | | 10 | 568 | 34 | 210 |
| Embodiment 1 | 100 | 0.1 | 420 | 23 | 15 |
| | | 1 | 468 | 25 | 26 |
| | | 10 | 476 | 27 | 38 |
| Embodiment 1 | 150 | 0.1 | 421 | 16 | 7 |
| | | 1 | 445 | 20 | 9 |
| | | 10 | 488 | 21 | 10 |
| Embodiment 1 | 300 | 0.1 | 422 | 15 | 5 |
| | | 1 | 463 | 32 | 32 |
| | | 10 | 559 | 31 | 148 |

As shown in Table 5 and FIG. 9, for Comparative Example 1, only short thin strip (0.1 g) can get the coercivity of 10 A/m or less at the heating rate of 300° C./min, and wound core samples (1 g, 10 g and 100 g) cannot possess the coercivity of 10 A/m or less at any heating rate. In Embodiment 1, temperatures under all heat treatment conditions are lower than the maximum temperature of Comparative Example 1, and grain sizes of crystals are smaller than those of Comparative Example 1 under almost any condition. Moreover, the alloy of Embodiment 1 also has lower coercivity than that of Comparative Example 1 under all heat treatment conditions, and wound cores (10 g) of Embodiment 1 also have the coercivity of 10 A/m or less at the heating rate of 150° C./min. Due to addition of the V element, on the one hand, dependency of coercivity on heat treatment heating rate is reduced (see FIGS. 2, 4, 5 and 6), and on the other hand, the heat treatment temperature range within which low coercivity can be obtained is expanded (see FIGS. 7-8). These results are applicable to actual industrialized production of the Fe-based nanocrystalline alloy and magnetic components of the present invention.

1. An alloy composition, wherein the expression of the alloy composition is FeₐV_{α}B_{b}Si_{c}PₓC_{y}Cu_{z} and 79≤a≤91 at %, 5≤b≤13 at %, 0≤c≤8 at %, 1≤x≤8 at %, 0≤y≤5 at %, 0.4≤z≤1.4 at %, 0<α<5 at % and 0.08≤z/x≤0.8.

2. The alloy composition of claim 1, wherein 0≤y≤3 at %, 0.4≤z≤1.1 at % and 0.08≤z/x≤0.55.

3. The alloy composition of claim 1, wherein 3 at % or less Fe can be replaced with at least one element selected from Ti, Zr, Hf, Nb, Ta, Mo, W, Cr, Co, Ni, Al, Mn, Ag, Zn, Sn, As, Sb, Bi, Y, N, O, Ca, Mg and rare-earth elements.

4. The alloy composition of claim 1, wherein the alloy composition can be shaped as a continuous thin strip.

5. The alloy composition of claim 4, wherein the continuous thin strip can bent tightly at 180 degrees as tested.

6. The alloy composition of claim 1, wherein the alloy composition can be shaped as powder.

7. The alloy composition of claim 1, wherein when the alloy composition is subjected to heat treatment, a temperature difference (ΔT=Tₓ₂−Tₓ₁) between a first crystallization start temperature (Tₓ₁) and a second crystallization start temperature (Tₓ₂) is 100-200° C.

8. The alloy composition of claim 1, wherein the alloy composition further comprises a nano-hetero structure having an amorphous phase and initial microcrystals existing in the amorphous phase, and the average grain size of the initial microcrystals is 0.3-10 nm.

9. A manufacturing method of a Fe-based nano-crystalline alloy, wherein it comprises the following steps: prepare the alloy composition of claim 1; subject the alloy composition to crystallization heat treatment.

10. A Fe-based nano-crystalline alloy, wherein the Fe-based nano-crystalline alloy is prepared according to the method of claim 9, with the coercivity of 20 A/m or less.

11. The Fe-based nano-crystalline alloy of claim 10, wherein the average crystallized grain size is 5-25 nm.

12. A magnetic component, wherein it comprises the Fe-based nano-crystalline alloy of claim 10.
